(19) United States
(12) Patent Application Publication
(10) Pub. No.: US 2004/0061476 A1
(43) Pub. Date: Apr. 1, 2004

(54) Prismatic battery

(75) Inventors: Hisao Nakamaru, Kamakura-shi (JP); Hideki Kasahara, Naka-gun (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/662,448

(22) Filed: Sep. 16, 2003

(30) Foreign Application Priority Data
Sep. 18, 2002 (JP) 2002-271943

(51) Int. Cl. H02J 7/00

(52) U.S. Cl. 320/107

(57) ABSTRACT

A prismatic battery with tabless current collectors. Electrode plates are wound to have a rectangular or elliptic cross section, and current collectors formed of metal plates having a shape conforming to this cross section are welded to the end faces of the belt-shaped current collecting portions of the electrode assembly. The metal plate includes a pair of lengthwise notches and a pair of widthwise notches respectively extending from the center to the periphery, and the opposing side edges of these notches protrude orthogonally from the metal plate to form connection pieces, which are welded to the belt-shaped current collecting portions of the electrode assembly.

The present disclosure relates to subject matter contained in priority Japanese Patent Application No. 2002-271943, filed on Sep. 18, 2002, the contents of which is herein expressly incorporated by reference in its entirety.

### BACKGROUND OF THE INVENTION

1. Field of the Invention

The present invention relates to a prismatic battery capable of charging and discharging with a large current.

2. Description of Related Art

With the progress of various portable electrical equipment, the development of battery technologies is now given much weight. Small rechargeable batteries using nickel metal hydride or lithium have been developed for cycling applications such as mobile phones and notebook PCs, and they are now beginning to find widespread application in other high-power electrical equipment such as electric tools, lawn mowers, and electric/gasoline hybrid cars. Improved batteries having excellent large-current charge/discharge characteristics are much desired for the application in high-power equipment.

One means of achieving large-current charge/discharge characteristics is to provide the battery with tabless current collectors that have good high-rate charge/discharge characteristics, as taught in Japanese Patent Laid-Open Publication No. 2002-151047. Flat plate current collectors are directly welded to the end faces of conductive portions, or bared edge portions (belt-shaped current collecting portions) of metal substrates without active materials thereon, of wound electrodes, so that current is collected evenly from the entire electrodes.

FIG. 6 shows one example of such tabless current collectors, denoted at 50. This current collector 50 is applied to cylindrical batteries wherein wound electrode assemblies are encased in a cylindrical case. Four rectangular notches 51 arranged with a spacing of 90° extend from near the center to the periphery of a circular metal plate. Each two opposing sides of the rectangular notches 51 are bent downward to form rib-like protrusions 52.

The current collectors 50 are abutted on the end faces of the opposite polarity belt-shaped current collecting portions protruding from both ends of the wound electrode assemblies such that the protrusions 52 are vertical. With the protrusions 52 extending across the belt-shaped current collecting portions of the electrodes, they are welded thereto using a pair of weld electrodes abutted to two longer side edges of the notches 51.

Prismatic batteries having a substantially rectangular or elliptic cross section are more suitable for enabling thinner designs of equipment than cylindrical batteries. Because of their high space efficiency and excellent heat dissipation properties, they are also considered a good candidate as a cell component of battery pack or module used as the power source of high-power electrical equipment.

Conventional prismatic batteries, however, do not employ the above tabless current collectors. Most commonly, strip-like lead plates or tabs, as they are called, of opposite polarity extend from one end face of wound electrode assemblies, one of which is directly welded to a sealing plate, while the other is welded to a terminal plate that is electrically insulated from the sealing plate. (see Japanese Patent Laid-Open Publication No. Hei. 11-25952, for example). Existing prismatic batteries in their present form are therefore not suited as the power source of high-power electrical equipment which requires charging and discharging with a large current, simply because of the lack of tabless current collectors designed for prismatic batteries.

U.S. Pat. No. 3,732,124 teaches another tabless current collector for a cylindrical battery. As shown in FIG. 7, this current collector 53 is made of a substantially square metal plate having rib-like projections 54 formed by bending both lengthwise edges downward at right angles, two U-shaped notches 57, and a hole 58 in the center for injecting electrolyte. Theoretically, this current collector 53 could be modified to have a longer rectangular shape conforming to the cross-sectional shape of prismatic batteries and adopted as their tabless current collectors.

However, with the above current collectors 53 conformed to a prismatic battery case, uniform electrical conduction across the electrodes and current collectors 53 will not be achieved because the pair of parallel projections 54 extending in the lengthwise direction will be abutted only on the outer peripheral parts of the belt-shaped current collecting portions of the electrodes. Also, the welding will be difficult because the projections 54 are arranged parallel to the belt-shaped current collecting portions.

If the welding is performed with a pair of weld electrodes abutted on both sides of the notch 57, a large idle current will flow across the weld electrodes through the flat plate part of the current collector 53 because of the relationship between the electrical resistance and the length of the current path, as a result of which the current flowing through the contact points between the projections 54 and belt-shaped current collecting portions will be too small to melt the contact points sufficiently and to form firm weld joints. The contact resistance at the weld joints will be accordingly large, and if the battery is discharged at the rate of 3C (3 times the battery's capacity), for example, the drop in voltage at the weld joints becomes large, leading to reduced battery performance.

### SUMMARY OF THE INVENTION

In light of the problems encountered in the prior art, it is an object of the present invention to provide a prismatic battery having tabless current collectors and being capable of charging and discharging with a large current.

To achieve the above object, the present invention provides a prismatic battery including: a case having a substantially rectangular or elliptic cross section; a wound electrode assembly of a positive electrode, a negative electrode, and a separator interposed therebetween encased in the case together with electrolyte, the electrodes comprising metal substrates and respective active material layers applied thereon, and projecting respectively on opposite ends of the assembly by belt-shaped current collecting portions formed of bared edge portions of the metal substrates of the electrodes, the portions being not coated with the active material layers; and a positive current collector and a negative current collector respectively welded to end faces of the belt-shaped current collecting portions of the electrodes. The current collectors each includes: a metal plate having a substantially rectangular or elliptic shape conforming to the cross section of the assembly; a pair of lengthwise notches extending from central locations to outer edges of lengthwise ends of the metal plate; a pair of widthwise notches extending from central locations to outer edges of widthwise ends of the metal plate; and connection pieces formed of opposing edges of the lengthwise notches and widthwise notches and protruding orthogonally to the plane of the metal plate, wherein weld joints are formed at intersections between the connection pieces and the belt-shaped current collecting portions of the electrodes.

The current collector of this prismatic battery has eight connection pieces at opposing edges of the four notches, which are formed radially from the central locations to the periphery, so that the weld joints between the connection pieces and belt-shaped current collecting portions of the electrodes are arranged evenly over the entire end face of the belt-shaped current collecting portions. Thereby, the battery is capable of high-rate charge and discharge due to the enhanced current collection efficiency. The notches decrease the idle current across the pair of weld electrodes to a considerable extent because most of the weld current flows through the shorter path and concentrates in the intersections between the connection pieces and belt-shaped current collecting portions rather than the detoured path through the metal plate. Firm weld joints are thus formed, with the connection pieces deeply biting into the belt-shaped current collecting portions. As a result, the battery is capable of charging and discharging with a large current due to the reduced internal resistance. Further, the wide-open lengthwise notches allow easy pouring of electrolyte into the case.

The prismatic battery of the invention is therefore capable of high-rate charge and discharge, and of charging and discharging with a large current, while satisfying the characteristics of prismatic batteries such as high space efficiency and excellent heat dissipation properties. This battery is particularly suited to construct a battery pack or module for the power source of high-power electrical equipment.

The battery case may have either a substantially rectangular or elliptic, i.e., stretched circle, cross section.

Preferably, the lengthwise notches should be formed in a V shape and opened at a preset angle, and the widthwise notches should be formed in a square shape.

By forming the lengthwise notches in a V shape, the connection pieces at the opposing edges of the notches intersect with the belt-shaped current collecting portions of the wound electrodes over the entire length. The weld joints, which are formed at these intersections, are therefore located evenly from the center to the periphery of the end face of the wound electrodes, ensuring an increase in the current collection efficiency.

The V-shaped lengthwise notches should preferably be opened at an angle ranging from 30° to 45°. The angle should be equal to or more than 30° so as to ensure easy pouring of electrolyte, but it should not exceed 45°, so that the weld joints between the lengthwise connection pieces and belt-shaped current collecting portions are arranged evenly along the length over the end face of the wound electrodes, for achieving current collection from the entire electrodes.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIG. 1A is a plan view of a prismatic battery according to a first embodiment of the invention, and FIG. 1B is a schematic view showing half of a longitudinal cross section of the battery;

FIG. 2 is a bottom view of a wound electrode assembly of the prismatic battery, to which a current collector has been welded;

FIG. 3 is a perspective view of the current collector;

FIG. 4 is a bottom view of an electrode assembly with a current collector welded thereto of a prismatic battery according to a second embodiment of the invention;

FIG. 5 is a bottom view of an electrode assembly with a current collector welded thereto of a prismatic battery according to a third embodiment of the invention;

FIG. 6 is a perspective view of a tabless current collector used in a conventional cylindrical battery; and

FIG. 7 is a perspective view of another tabless current collector used in a conventional cylindrical battery.

### DETAILED DESCRIPTION OF THE PREFERRED EMBODIMENTS

Preferred embodiments of the present invention will be hereinafter described with reference to the accompanying drawings.

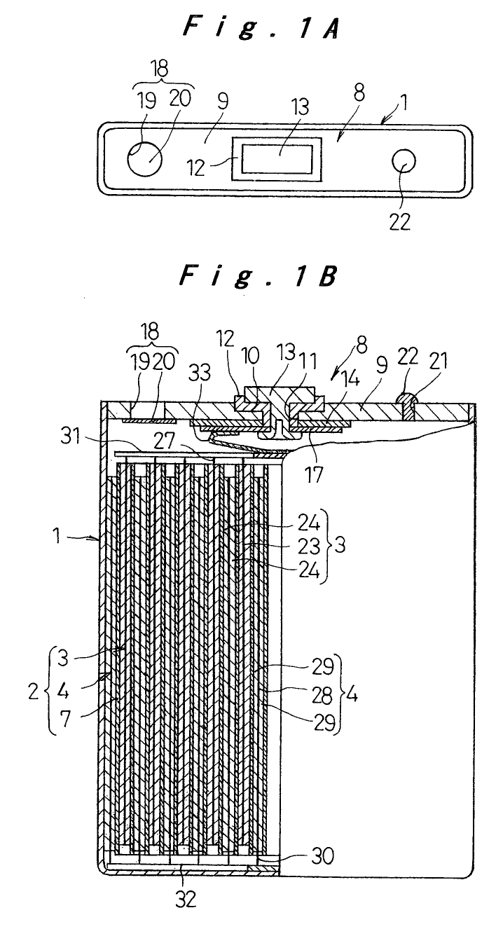

FIG. 1A is a plan view of a prismatic battery according to a first embodiment of the invention, and FIG. 1B is a schematic view showing half of a longitudinal cross section of the battery. As is seen from FIG. 1A, the prismatic battery includes a bottomed, square tube case 1 having a substantially rectangular cross section, in which are accommodated a wound electrode assembly 2 including a positive electrode 3 and a negative electrode 4, and a separator 7 interposed therebetween, together with electrolyte (not shown). A sealing plate 9 forming a sealing member 8 is fitted to the open end of the battery case 1 and joined to the inner peripheral edge of the case 1 by laser welding so as to seal the case 1 in an air tight manner. The wound electrode assembly 2 will be described in more detail later.

The sealing plate 9, which is substantially rectangular, has a recess 10 at the center, in the middle of which a through hole 11 is formed. In the hole 11 is fitted an upper insulating gasket 12 made of electrolyte-resistant and electrically insulating synthetic resin and coated with a sealant containing blown asphalt, upon which a positive terminal 13 is attached. The positive terminal 13 is a rivet of nickel or nickel-plated steel, which is fixed to the sealing plate 9 by swaging, with a lower insulating gasket 14 and a washer or terminal plate 17 sandwiched between itself and the plate 9 such as to make tight contact with both gaskets 12, 14 to form an air- and liquid-proof seal.

On one side of the positive terminal 13 (left side in FIG. 1A) in the sealing plate 9 is formed a discharge hole 19, which is closed by a piece of nickel foil 20 fixedly attached to the inner face of the plate 9, to form a safety vent 18 for preventing explosion. On the opposite side of the positive terminal 13 (right side) is another hole 12 for injecting a preset amount of electrolyte after the sealing plate 9 is welded to the battery case 1. The hole 21 is closed by a plug 22 thereafter.

The positive electrode 3 has a metal substrate 23 of, e.g., metal foil, and active material layers 24 formed on both sides thereof. The positive electrode 3 has a bared edge portion on one side in the widthwise direction (upper side in FIG. 1B) where the metal substrate 23 is not coated with the active material mixture. This bared edge portion protrudes farther than the separator 7 in the widthwise direction and functions as a belt-shaped current collecting portion 27 of the positive electrode.

The negative electrode 4 has a metal substrate 28 of, e.g., thin punched metal sheet, and active material layers 29 formed on both sides thereof. The negative electrode 4 has a bared edge portion on one side in the widthwise direction (lower side in FIG. 1B), which protrudes farther than the separator 7 in the opposite direction from the belt-shaped current collecting portion 27 of the positive electrode, and functions as a belt-shaped current collecting portion 30 of the negative electrode.

This embodiment shows one example of an alkaline rechargeable battery; the active material layer 24 of the positive electrode mainly contains nickel hydroxide, and the active material layer 29 of the negative electrode mainly contains a hydrogen-absorption alloy. The separator 7 is made of a polypropylene or polyethylene nonwoven cloth that has undergone hydrophilic treatment such as sulfonation. The electrolyte is a solution of potassium hydroxide.

A positive electrode current collector 31 and a negative electrode current collector 32 are welded to the end faces of the belt-shaped current collecting portions 27 and 30 of the positive and negative electrodes by resistance welding, respectively. The battery has the wound electrode assembly 2 accommodated in the prismatic case 1, and yet because of the novel structure, the current is collected evenly from the entire positive and negative electrodes 3, 4 by means of tabless current collectors. The positive electrode current collector 31 is connected to the terminal plate 17 with a lead plate 33, and the negative electrode current collector 32 is connected to the bottom of the case 1 by resistance welding.

While this embodiment shows one example in which the battery case 1 has a substantially rectangular cross section, the invention can also be applied to a case that has other cross-sectional shapes such as an ellipse or stretched circle including parallel lines.

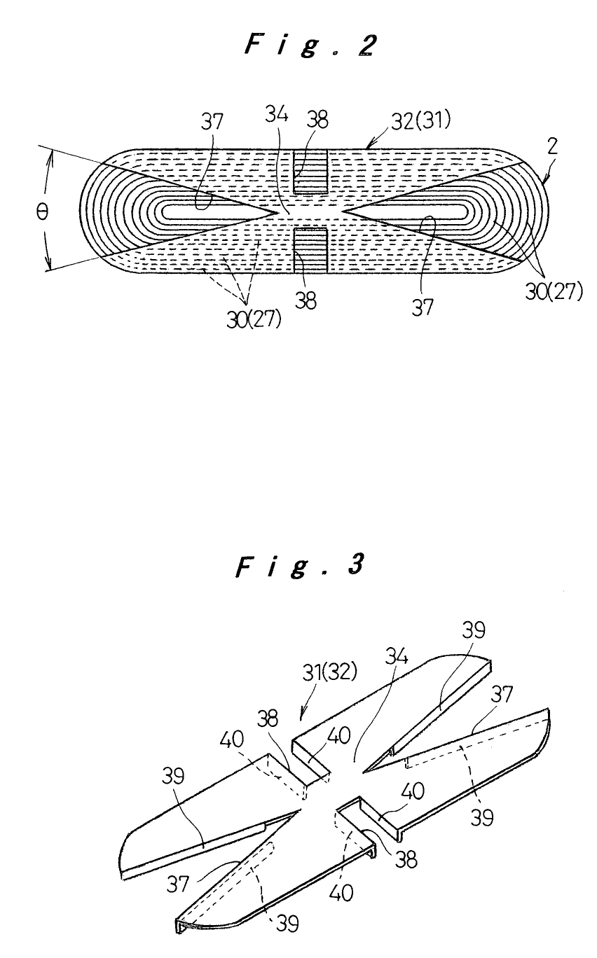

FIG. 2 is a bottom view of the wound electrode assembly 2 with the current collectors 31, 32 welded thereto, and FIG. 3 is a perspective view of the positive electrode current collector 31. While the negative electrode current collector 32 has the size that generally equals to that of the end face of the electrode assembly 2, the positive electrode current collector 31 is shaped somewhat smaller than that, as seen from FIG. 1B. This is to prevent short-circuiting caused by the collector 31 contacting the inner face of the battery case 1, which is of opposite polarity.

The current collectors 31, 32 are metal plates 34 having an elliptic shape conforming to the cross-sectional shape of the wound electrode assembly 2. The metal plates 34 have deep V-shaped notches 37 at both lengthwise ends, and narrow square notches 38 at both widthwise ends (at the center along the longitudinal direction) in a symmetrical arrangement.

The lengthwise notches 37 extend from two locations on both sides of the center of the metal plate 34 toward lengthwise direction, gradually spreading in the widthwise direction, to the periphery of the metal plate 34. The narrow square widthwise notches 38 extend from two locations on both sides in the widthwise direction of the center to the periphery of the metal plate 34. The opposing edges of the lengthwise notches 37 and widthwise notches 38 are bent downward to form rib-like connection pieces 39, 40, as shown in FIG. 3.

These connection pieces 39, 40 of the current collectors 31, 32 are joined to the belt-shaped current collecting portions 27, 30 by resistance welding, using a pair of weld electrodes abutted on the opposing edges of the notches 37, 38, with pressure and a preset AC current being applied across the electrodes. The weld electrodes should preferably have square tips that are long enough to stretch over the edges of the notches 37, 38, so as to achieve simultaneous welding of multiple intersections between the connection pieces 39, 40 and belt-shaped current collecting portions 27, 30.

The eight connection pieces 39, 40 formed at the opposing edges of the four notches 37, 38 of the current collector 31, 32 are arranged radially from the center to the periphery of the elliptic shape so that each connection piece 39, 40 extends entirely across the belt-shaped current collecting portions 27, 30, whereby the weld points between the connection pieces 39, 40 and belt-shaped current collecting portions 27, 30 are evenly distributed over the end face of the wound electrode assembly 2. This structure enhances the current collection efficiency and enables high-rate charge and discharge.

Because the connection pieces 39, 40 are bent orthogonally to the metal plate 34, most of the current flows through the intersections between the connection pieces 39, 40 and belt-shaped current collecting portions 27, 30, which is the shorter path, and there is very little idle current flowing across the pair of weld electrodes, through the longer, detoured path along the periphery of the notches 37, 38 in the metal plate 34. The weld current is thus concentrated in small area, whereby the connection pieces 39, 40 firmly bite into the belt-shaped current collecting portions 27, 30, forming strong joints. The weld joints between the current collectors 31, 32 and the belt-shaped current collecting portions 27, 30 thus have sufficient weld strength and tension strength, whereby the internal resistance of the battery is reduced and charging and discharging with a large current are made possible.

When injecting electrolyte from the hole 21 after encasing the electrode assembly 2 with the current collectors 31, 32 into the battery case 1, the lengthwise notches 37 are useful as a guide, enabling smooth pouring of the electrolyte. For this purpose, the lengthwise notches 37 should preferably be opened at an angle of equal to or more than 30°. This angle may be determined in accordance with the length and width of the current collectors 31, 32, but it should not exceed 45°. If the angle is over 45°, then the weld joints between the connection pieces 39 and belt-shaped current collecting portions 27, 30 will be located too much toward the center of the electrode assembly 2, and current collection from the lengthwise ends of the electrode assembly 2 will be insufficient.

The prismatic battery of the invention employs a prismatic battery case 1 and therefore can advantageously be used in thin equipment. It has high space efficiency and excellent heat dissipation properties, and is capable of high-rate charge and discharge, and of charging and discharging with a large current. This battery is therefore particularly suitable for constructing a battery pack or module to form a power source of high-power electrical equipment.

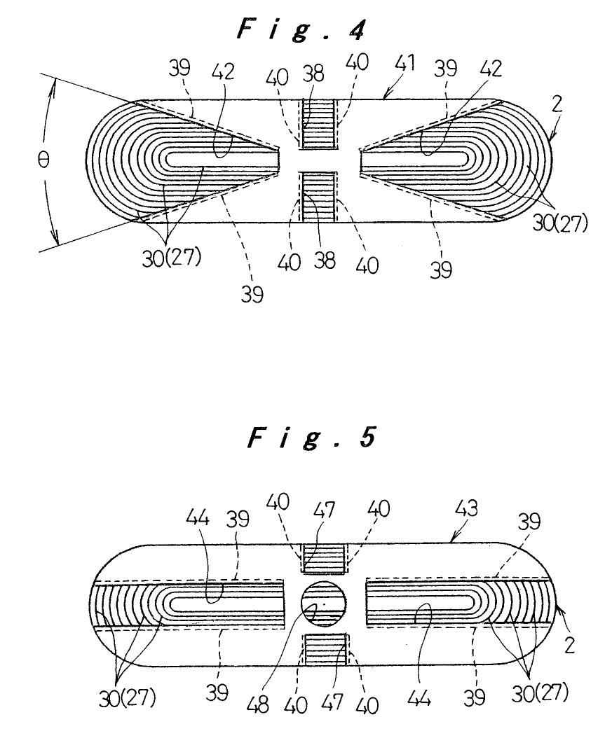

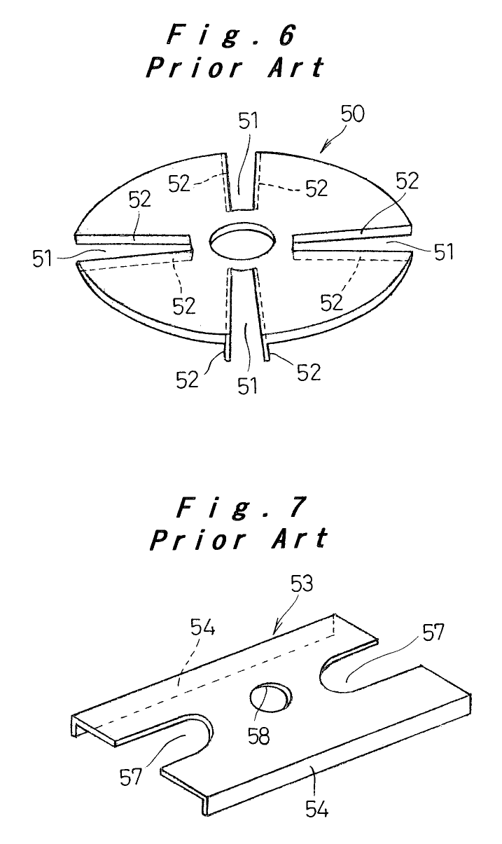

FIG. 4 is a bottom view of an electrode assembly 2 of a prismatic battery according to a second embodiment of the invention, to which a current collector 41 has been welded. Elements that are identical or similar to those of FIG. 2 are given the same reference numerals. The current collector 41 differs from that of FIG. 2 in that lengthwise notches 42 are formed in a truncated V shape, and that the notches 42 open at a wider angle than that of the current collector 32. This current collector allows even easier pouring of electrolyte, while achieving the same effects as with the first embodiment.

FIG. 5 is a bottom view of an electrode assembly 2 of a prismatic battery according to a third embodiment of the invention, to which a current collector 43 has been welded. Elements that are identical or similar to those of FIG. 2 are given the same reference numerals. The current collector 43 differs from the current collector 32 in that lengthwise notches 44 are formed in a rectangular shape, and widthwise notches 47 are made shorter to form a circular hole 48 therebetween for injecting electrolyte. As compared to the foregoing embodiments, this prismatic battery allows pouring of electrolyte with less ease, and the connection pieces 39 and belt-shaped current collecting portions 27, 30 intersect each other in a slightly shorter distance. Nevertheless, it is clearly different from the conventional battery with the current collector 53 of FIG. 7, and is capable of high-rate charge and discharge, and of charging and discharging with a large current.

As described above, the current collectors of the prismatic battery of the invention have radially arranged connection pieces that are engaged with and welded to the belt-shaped current collecting portions of the electrode assembly. The battery is therefore capable of high-rate charge and discharge due to the enhanced current collection efficiency. The idle current during welding is made low by the notches in the current collectors, whereby the weld current concentrates in the intersections between the connection pieces and belt-shaped current collecting portions. The resultant firm weld joints ensure a low internal resistance and enable the battery to charge and discharge with a large current. The notches formed in the lengthwise direction are also useful when pouring liquid electrolyte into the battery. The prismatic battery thus satisfies all the characteristics of prismatic batteries that are suitable for thin equipment, and have high space efficiency and excellent heat dissipation properties, and is capable of high-rate charge and discharge, and of charging and discharging with a large current.

Although the present invention has been fully described in connection with the preferred embodiment thereof, it is to be noted that various changes and modifications apparent to those skilled in the art are to be understood as included within the scope of the present invention as defined by the appended claims unless they depart therefrom.

What is claimed is:

1. A prismatic battery comprising:
a battery case having a substantially rectangular or elliptic cross section;
a wound electrode assembly of a positive electrode, a negative electrode, and a separator interposed therebetween encased in said battery case together with electrolyte, the electrodes comprising metal substrates and respective active material layers applied thereon, and projecting respectively on opposite ends of the assembly by belt-shaped current collecting portions formed of bared edge portions of the metal substrates of the electrodes, the portions being not coated with the active material layers; and
a positive current collector and a negative current collector respectively welded to end faces of the belt-shaped current collecting portions of the electrodes, said current collectors each comprising:
a metal plate having a substantially rectangular or elliptic shape conforming to a cross section of said electrode assembly;
a pair of lengthwise notches extending from central locations to outer edges of lengthwise ends of the metal plate;
a pair of widthwise notches extending from central locations to outer edges of widthwise ends of the metal plate; and
connection pieces formed of opposing edges of said lengthwise notches and said widthwise notches and protruding orthogonally to the plane of the metal plate, wherein weld joints are formed at intersections between said connection pieces and said belt-shaped current collecting portions of the electrodes.

2. The prismatic battery according to claim 1, wherein said lengthwise notches are formed in a V shape and opened at a preset angle, and said widthwise notches are formed in a square shape.

3. The prismatic battery according to claim 2, wherein said lengthwise notches are opened at an angle ranging from 30° to 45°.
